(19) United States
(12) Patent Application Publication
(10) Pub. No.: US 2014/0189870 A1
(43) Pub. Date: Jul. 3, 2014

(54) VISUAL COMPONENT AND DRILL DOWN MAPPING

(71) Applicants: Anurag Singla, Cuperlino, CA (US); David Earl Wiser, Eugene, OR (US)

(72) Inventors: Anurag Singla, Cuperlino, CA (US); David Earl Wiser, Eugene, OR (US)

(21) Appl. No.: 14/239,915

(22) PCT Filed: Sep. 7, 2012
(86) PCT No.: PCT/US2012/054193

§ 371 Date: Feb. 20, 2014

Related U.S. Application Data
(60) Provisional application No. 61/532,455, filed on Sep. 8, 2011.

(51) Int. Cl. G06F 21/55

(52) U.S. Cl. CPC G06F 21/55
USPC 726/23

(57) ABSTRACT

A drill down manager system may include an introspect module to determine fields for visual components, and a mappings module to map a drill down to a visual component based on the fields and data outputs for the drill down. The system may present the data outputs for the drill down in the visual component mapped to the drill down.

### PRIORITY

The present application claims priority to U.S. provisional patent application Ser. No. 61/532,455, filed Sep. 8, 2011, which is incorporated by reference in its entirety.

### BACKGROUND

Computer networks and systems have become indispensable tools for modern business. Today terabits of information on virtually every subject imaginable are stored in and accessed across such networks by users throughout the world. Much of this information is, to some degree, confidential and its protection is required. Not surprisingly then, intrusion detection systems (IDS) have been developed to help uncover attempts by unauthorized persons and/or devices to gain access to computer networks and the information stored therein.

Intrusion detection may be regarded as the art of detecting inappropriate, incorrect or anomalous activity within or concerning a computer network or system. Data for detecting intrusions may be collected from a variety of sources. For example, data monitors for different types of network devices, such as routers, firewalls, etc., may monitor different types of data to detect attacks. Due to the different types of data that are provided from many different data sources, it is difficult to correlate the different types of data across the many data sources to present desired information related to intrusions.

### BRIEF DESCRIPTION OF DRAWINGS

The embodiments are described in detail in the following description with reference to examples shown in the following figures.

FIG. 1 illustrates a drill down manager system.

FIG. 2 illustrates a security information and event management system.

FIG. 3 illustrates a method.

FIG. 4 illustrates a computer system that may be used for the method and systems.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It is apparent that the embodiments may be practiced without limitation to all the specific details. Also, the embodiments may be used together in various combinations.

According to an embodiment, a drill down manager system determines the inputs and outputs of drill downs and determines which visual components can provide the data for the drill downs. A drill down may include moving from presented information to more detailed information about at least some of the presented information. Visual components may include display tools for presenting data. Each display tool may present data in a different format and may also display different data. For example, one format may include displaying values infields for each event in rows. Another format may present summary information for events in an active channel. In another example, a visual component may display bandwidth usage or failed login attempts graphically in a chart or in a bar graph by user. In another example, a visual component may list query results. Examples of the visual components may include active channels, dashboards, query viewers, and data monitors, which are described in further detail below. The drill down manager system automatically creates a mapping of one or more visual components for each drill down. Drill downs can be predefined or dynamically created. As new drill downs are added or new visual components are added or removed, the drill down manager automatically finds the mappings.

The drill down manager system maps drill downs across multiple different types of visual components. Thus, the user is not limited to a data view that is only specific to the data available from a single visual component. This provides an opportunity for the user to view many different types of data available from multiple visual components at various granularities. Also, the drill down manager system may store multiple drill downs and present a user with drill downs that are matched with the user. For example, a user may view drill downs for which they are authorized to view. The drill down manager system may group drill downs by user type (e.g., analyst or executive) and present the group of drill downs matching the user's type. Drill down groupings may be organized in a hierarchy which may coincide with an organization hierarchy.

An example of the type of data for which drill downs may be performed and visual components be displayed is event data, however, any type of data may be used. Event data includes any data related to an activity performed on a computer device or in a computer network. The event data may be correlated and analyzed to identify network or computer security threats. The activity may be associated with a user, also referred to as an actor, to identify a security threat and the cause of the security threat. Activities may include logins, logouts, sending data over a network, sending emails, accessing applications, reading or writing data, etc. A security threat may include activities determined to be indicative of suspicious or inappropriate behavior, which may be performed over a network or on systems connected to a network. A common security threat, by way of example, is a user or code attempting to gain unauthorized access to confidential information, such as social security numbers, credit card numbers, etc., over a network.

The data sources for the event data may include network devices, applications or other types of data sources described below operable to provide event data that may be used to identify network security threats. Event data describing events may be captured in logs or messages generated by the data sources. For example, intrusion detection systems (IDSs), intrusion prevention systems (IPSs), vulnerability assessment tools, firewalls, anti-virus tools, anti-spam tools, and encryption tools may generate logs describing activities performed by the source. Event data may be provided, for example, by entries in a log file or a syslog server, alerts, alarms, network packets, emails, or notification pages.

Event data can include information about the device or application that generated the event. The event source is a network endpoint identifier (e.g., an IP address or Media Access Control (MAC) address) and/or a description of the source, possibly including information about the product's vendor and version. The time attributes, source information and other information is used to correlate events with a user and analyze events for security threats.

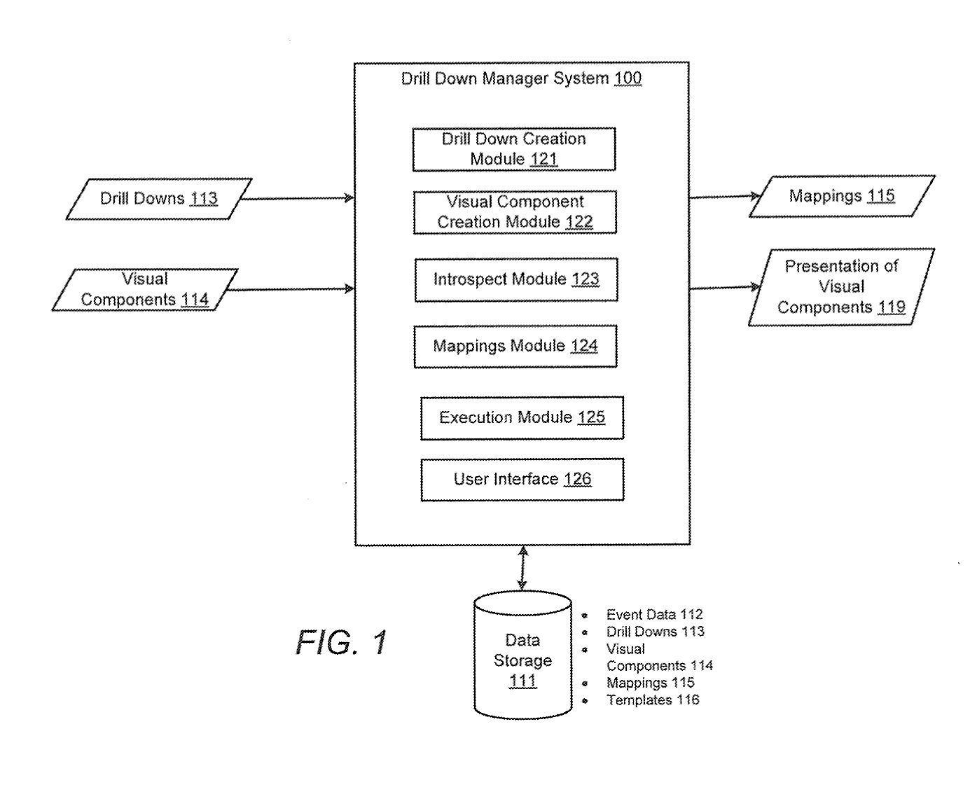

FIG. 1 illustrates a drill down manager system 100, according to an embodiment. The drill down manager system 100 may include a drill down creation module 121, a visual component creation module 122, an introspect module 123, a mappings module 124, an execution module 125 and a user interface 126. The components of the system 100 may comprise hardware, machine readable instructions or a combination of hardware and machine readable instructions. The machine readable instructions may be stored on a storage device and executed by one or more processors.

The drill down manager system 100 provides a desired granularity of visibility of event data across different data inputs and different visual components to present information as requested by a user or another system. The drill down creation module 121 creates and stores drill downs 113 in data storage 111. A drill down may include a presentation of data correlated from captured event data. The information in a drill down may be determined from the requirements provided by a user for the drill down. The requirements may specify data inputs, data outputs, and/or a function to calculate a data output. This information is stored in the data storage 111 to represent the drill down. A user can also specify further constraints on the data inputs in terms of fields (static or dynamically available in the system), field data types, or the actual run-time input values satisfying a function. A user may create a drill down through the user interface 126 by selecting or providing the information for the drill down. For example, the user may select fields, constraints, etc., for the drill down through the user interface 126 and store the drill down in the data storage 111. The user interface 126 may comprise a graphical user interface generated on a display.

Drill downs 113 and visual components 114 are shown as data inputs to the system 100. Drill downs 113 and visual components 114 may be retrieved from the data storage 111 and provided as the inputs. Also, mappings 115 that may be generated as an output of the system 100 may be stored in the data storage 111. Presentation of visual components 119 represents, for example, the system 100 displaying a visual component on a display with the desired data. Also, event data 111 may be received from data sources and stored in the data storage 111. Templates 116 which may be used for creating visual components or drill downs may be stored in the data storage 111.

The visual component creation module 122 creates and stores visual components in the data storage 111. Visual components 114 may include display tools for presenting data. The visual components 114 may be used for forensic investigation on captured event data. Examples of the visual components 114 include active channels, dashboards, query viewers, data monitors. A dashboard may include a graphical user interface (GUI) that presents different screens for a user to interact with the system 100. For example, through a dashboard, a user may create drill downs and view the output of a drill down. A dashboard may be presented through the user interface 126.

Query viewers and data monitors may provide information viewable through the user interface 126. A query viewer may display query results in the user interface 126. Data monitors may display statistics (e.g., in real time) for event data. For example, a user may select event fields to display in a data monitor to identify attackers.

An active channel may include events that match conditions. The active channel may be a live flow of events detected from the event data that match the conditions. The active channel may be events of interest to a user that are identified based on conditions provided by the user. For example, an active channel may include events comprised of failed logins that are continually identified from the captured event data which is continuously received. The events in an active channel may be viewed in the user interface 126. The active channel may be comprised of the finest granularity of event data before aggregation.

Information representing each of the visual components 114 may be stored in the data storage 111. In one example, templates 116 for different types of visual components may be stored in the data storage 111. Each template may be for a different type of visual component and includes the presentation elements of each type of visual component. The elements may include borders, text display windows, font size, font color, buttons, drop down menus, etc. Stock fields may also be included in a template. A user may select different fields to include in a particular template for a particular type of visual component to generate a visual component. The user selections for the template may be stored in the data storage 111 to create a visual component.

The introspect module 123 determines the fields and the data type for each field of the visual components 114. For example, the visual components 114 may include one hundred data monitors, fifty query viewers, one hundred active channels, etc. The introspect module 123 analyzes the information for the visual components 114 which may be stored in the data storage 111 to determine the fields in each visual component and the data type for each field. Fields may be for captured event data or for information calculated from captured event data. Examples of fields may include source IP address, MAC address, receipt time, user ID, in-bytes, out-bytes, total bandwidth, etc. Data types may include numeric ranges, a string of predetermined length, integer, etc. Any newly received visual component may be introspected when received to determine the fields and the data type for each field.

The mappings module 124 maps one or more of the visual components 114 to each of the drill downs 113 based on outputs for the drill down and the fields identified for the visual components 114. Constraints in the drill down may be used for the mapping as well. The introspect module 123 may determine the inputs, outputs, constraints and other information for the drill downs 113, for example, from metadata stored in the data storage 111 describing this information. In an example, a drill down is defined that has as data outputs a user ID and user type in an organization hierarchy for consecutive failed login attempts greater than a threshold for a predetermined time period. The mappings module 124 identifies a data monitor that has fields for user ID and failed login attempts and time stamps for the failed login attempts, and identifies a query viewer that has a field for user ID and user type in the organization hierarchy. An association is created between the drill down and the data monitor and query viewer. The association, for example, links the drill down ID with the IDs of the data monitor and query viewer. The association is stored as a mapping. Mappings 115 may be stored for each drill down. If a visual component does not exist to show the desired data for a drill down, then a visual component may be created and stored in the data storage 111, and a mapping is created between the drill down and the newly created visual component.

Data type mappings may also be performed. For example, an input for a drill down may specify an IP address data type for an input. An event may include multiple IP addresses (e.g., source IP address, destination IP address, etc.). Each IP address field from a visual component may be mapped to the input of the drill down because they have the same data type.

The execution module 125 executes a drill down and generates a presentation 119 of any visual components mapped to the drill down. The presentation may be via the user interface 126. For example, if the user is viewing event data in a dashboard or an active channel, the user may select a drill down for event data currently being shown. The drill down may represent more detailed information about the event data. For example, as described in the example, a visual component, such as a query viewer, may be executed to display a user ID and a user type in an organization hierarchy for consecutive failed login attempts greater than a threshold within a predetermined time period.

The execution module 125 may present a user with drill downs that are matched with the user. For example, a user may view drill downs for which they are authorized to view. The drill down manager system 100 may group drill downs by user type (e.g., analyst or executive) and present the group of drill downs matching the user's type. Drill down groupings may be organized in a hierarchy which may coincide with an organization hierarchy.

The data storage 111 may include a database, an online analytical data storage system or another type of data storage system. The data storage 111 may include hardware, such as hard drives, memory, processing circuits, etc., for storing data and executing data storage and retrieval operations,

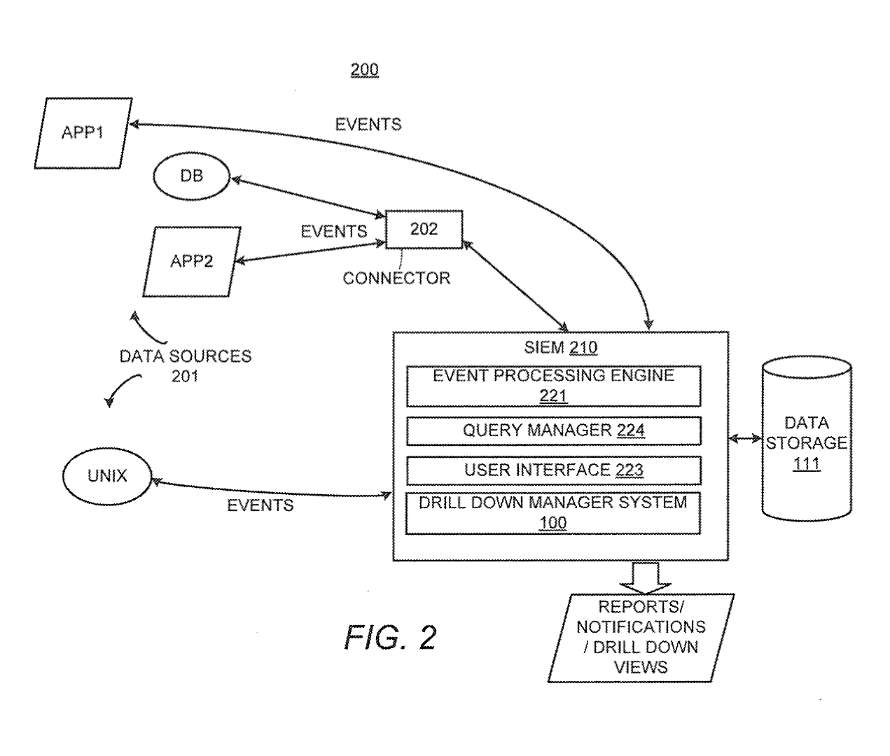

FIG. 2 illustrates an environment 200 including security information and event management system (SEM) 210, according to an embodiment. The SIEM 210 processes event data, which may include real-time event processing. The SIEM 210 may process the event data to determine network-related conditions, such as network security threats. Also, the SIEM 210 is described as a security information and event management system by way of example. The SIEM 210 is a system that may perform event data processing related to network security as an example. It is operable to perform event data processing for events not related to network security.

The environment 200 includes data sources 201 generating event data for events, which are collected by the SIEM 210 and stored in the data storage 111. The data storage 111 may include a database or other type of data storage system. The data storage 111 may include memory for performing in-memory processing and/or non-volatile storage for storing event data and performing data operations. The data storage 111 may store any data used by the SIEM 210 to correlate and analyze event data.

The data sources 201 may include network devices, applications or other types of data sources operable to provide event data that may be analyzed. Event data may be captured in logs or messages generated by the data sources 201. The data sources, for example, may include network devices, intrusion prevention systems (IPSs), vulnerability assessment tools, anti-virus tools, anti-spam tools, encryption tools, and business applications. Event data is retrieved for example from data source logs and stored in the data storage 111. Event data may be provided, for example, by entries in a log file or a syslog server, alerts, alarms, network packets, emails, or notification pages. The data sources 201 may send messages to the SEM 210 including event data. Event data is any information captured by the data sources 201 related to network activity and/or security.

Event data can include information about the source that generated the event and information describing the event. For example, the event data may identify the event as a user login. Other information in the event data may include when the event was received from the event source (“receipt time”). The receipt time is a date/time stamp. The event data may describe the source, such as an event source is a network endpoint identifier (e.g., an IP address or Media Access Control (MAC) address) and/or a description of the source, possibly including information about the product's vendor and version. The date/time stamp, source information and other information may then be used for correlation performed by the event processing engine 221. The event data may include meta data for the event, such as when it took place, where it took place, the user involved, etc.

Examples of the data sources 201 are shown in FIG. 1 as Database (DB), UNIX, App1 and App2. DB and UNIX are systems that include network devices, such as servers, and generate event data. App1 and App2 are applications that generate event data. App1 and App2 may be business applications, such as financial applications for credit card and stock transactions, IT applications, human resource applications, or any other type of applications.

Other examples of data sources 201 may include security detection and proxy systems, access and policy controls, core service logs and log consolidators, network hardware, encryption devices, and physical security. Examples of security detection and proxy systems include IDSs, IPSs, multipurpose security appliances, vulnerability assessment and management, anti-virus, honeypots, threat response technology, and network monitoring. Examples of access and policy control systems include access and identity management, virtual private networks (VPNs), caching engines, firewalls, and security policy management. Examples of core service logs and log consolidators include operating system logs, database audit logs, application logs, log consolidators, web server logs, and management consoles. Examples of network devices include routers and switches. Examples of encryption devices include data security and integrity. Examples of physical security systems include card-key readers, biometrics, burglar alarms, and fire alarms. Other data sources may include data sources that are unrelated to network security.

The connector 202 may include code comprised of machine readable instructions that provide event data from a data source to the SEM 210. The connector 202 may provide efficient, real-time for near real-time) local event data capture and filtering from one or more of the data sources 201. The connector 202, for example, collects event data from event logs or messages. The collection of event data is shown as “EVENTS” describing event data from the data sources 201 that is sent to the SEM 210. Connectors may not be used for all the data sources 201.

The SIEM 210 collects and analyzes the event data. Events can be cross-correlated with rules to create meta-events. Correlation includes, for example, discovering the relationships between events, inferring the significance of those relationships, e.g., by generating meta events, prioritizing the events and meta-events, and providing a framework for taking action. The SIEM 210, which in one example is comprised of machine readable instructions executed by computer hardware such as a processor, enables aggregation, correlation, detection, and investigative tracking of activities. The system also supports response management, ad-hoc query resolution, reporting and replay for forensic analysis, and graphical visualization of network threats and activity.

The SIEM 210 may include may include hardware and/or machine readable instructions executed by hardware, such as one or more processors. The event processing engine 221 processes events according to rules and instructions, which may be stored in the data storage 111. The event processing engine 221, for example, correlates events in accordance with rules, instructions and/or requests. For example, a rule indicates that multiple failed logins from the same user on different machines performed simultaneously or within a short period of time is to generate an alert to a system administrator. The event processing engine 221 may provide the time, location, and user correlations between multiple events when applying the rules.

The user interface 223 may be used for communicating or displaying reports or notifications about events and event processing to users. The user interface 223 may provide a dashboard for a user to interact with the SIEM 210 and present requested information. The user interface 223 may include a graphic user interface that may be web-based. The user interface 223 may be used as the user interface 126 of the drill down manager system 100 to present the visual components 114, and may display additional information related to event processing performed by the SIEM 210.

As described above, the drill down manager system 100 provides a desired granularity of visibility of event data across different visual components to present information as requested by a user or another system. Examples of the visual components include active channels, dashboards, query viewers, data monitors. Query viewers may interact with the query manager 224 to run queries on captured event data and display query results via the user interface 223. The user interface 223 may display reports, notifications, drill down views, or any output of visual components.

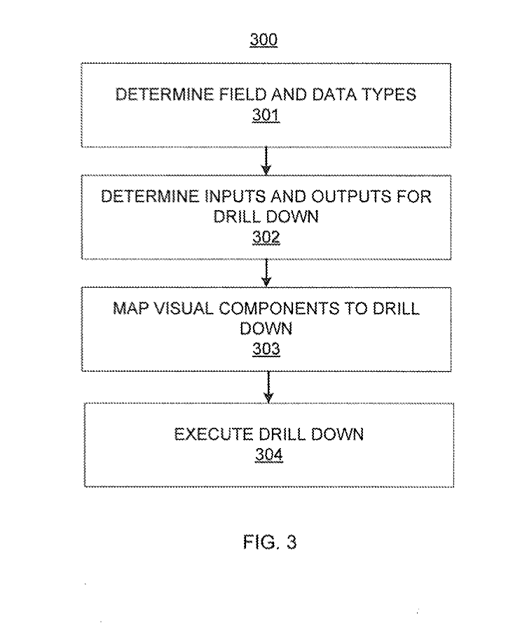

FIG. 3 illustrates a method 300 according to an embodiment. The method 300 is described with respect to the drill down manager system 100 shown in FIGS. 1 and 2 by way of example. The method 300 may be performed in other systems.

At 301, the introspect module 123 determines the fields in each of the visual components 114 and the data type for each field and stores this information. For example, the visual components 114 may include one hundred data monitors, fifty query viewers, one hundred active channels, etc. The introspect module 123 determines the fields in each visual component and the data type for each field, for example, from metadata stored for each visual component. Fields may be for captured event data or for information calculated from captured event data. Examples of fields may include source IP address, MAC address, receipt time, user ID, in-bytes, out-bytes, total bandwidth, etc. Data types may include numeric ranges, a string of predetermined length, integer, etc. Any newly received visual component may be introspected when received to determine the fields and the data type for each field. Also, fields and data types may have already been determined for the visual components 114, however, if a new visual component is created, the fields and data types are determined for the new visual component.

At 302, the introspect module 123 determines inputs and outputs for the drill downs 113, which may include a newly received drill down, are determined. Constraints and functions for the drill downs 113 may also be determined.

At 303, the mappings module 124 maps one or more of the visual components 114 to each of the drill downs 113 based at least on the outputs for the drill down and the fields identified for the visual components 114. The drill down inputs and constraints and functions may also be used to determine the mappings. For example, a drill down is defined that has as outputs user ID and user type in the organization hierarchy for consecutive failed login attempts greater than a threshold for a predetermined time period. The mappings module 124 identifies a data monitor that has fields for user ID and failed login attempts and time stamps for the failed login attempts, and identifies a query viewer that has a field for user ID and user type in the organization hierarchy. In another example, data type mappings may also be performed. For example, an input for a drill down may specify an IP address data type for an input. An event may include multiple IP addresses (e.g., source IP address, destination IP address, etc.). Each IP address field from a visual component may be mapped to the input of the drill down because they have the same data type. The mappings may be stored in the data storage 111.

At 304, the execution module 125 executes a drill down to present a view of the drill down. For example, a user may select a drill down from information presented for events. In an example, the selected drill down provides additional information for users that have successive failed login attempts. The execution module 125 identifies one or more of the visual components mapped to the drill down to display a view of the drill down. The visual components mapped to the drill down may be determined from the mappings stored in the data storage 111. For example, a data monitor mapped to the drill down may present failed login attempts for each user ID and time stamps, and a query viewer mapped to the drill down may present the user ID, user type in an organization hierarchy (e.g., business analyst, accountant, director, etc.), number of failed login attempts for the user ID and timestamps for the failed login attempts.

The execution module 125 executes the drill down by obtaining a user ID and failed login attempts for each user ID and time stamps from a data monitor mapped to the drill down. For each user ID, the execution module 125 obtains the user type in the hierarchy from the query viewer. The execution module 125 runs a function to determine if failed login attempts for each user ID exceeds a threshold for the predetermined period of time, and presents a view that indicates the user ID, user type, and number of consecutive failed login attempts within the time period. The function may be provided by the user when creating the drill down.

The execution module 125 identifies one or more of the visual components mapped to the drill down to display a view of the drill down. For example, a data monitor mapped to the drill down may present failed login attempts for each user ID and time stamps, and a query viewer mapped to the drill down may present the user ID, user type in an organization hierarchy (e.g., business analyst, accountant, director, etc.), number of failed login attempts for the user ID and timestamps for the failed login attempts. The identified visual components may be used to display the information for the drill down. For example, the data monitor mapped to the drill down may present failed login attempts for each user ID and time stamps, and a query viewer mapped to the drill down may present the user ID, user type in an organization hierarchy (e.g., business analyst, accountant, director, etc.), number of failed login attempts for the user ID and timestamps for the failed login attempts.

Through the drill down manager 122, a user can define useful drill downs and let these be discovered and made available automatically. In addition, drill down groups can be created which can be auto-discovered and utilized by visual components to generate drill down views. In one example, a subset of drill downs are applicable for a visual component from a drill down list, and those drill-clowns are automatically made available. A user can also manually associate drill downs or drop down lists to visual components. A visual data component can have links to multiple grouping of forensic investigation mechanisms, and customization of the investigations may be performed. For example, in one approach, an analyst is given one set of options/default values for low-level, detailed investigations, while an executive is given another set of options/default values for more of an overview. The access to drill downs can also be restricted using user permissions.

The creation of drill downs and drill down lists may be independent of the visual components which are later mapped to the drill downs. The drill downs can accept optional parameters that the visual data components can provide at execution time. The drill downs and drill down lists can then be automatically discovered by the visual components and used. Also, a user may manually associate drill downs and drill down lists to visual components. Also, the drill down manager 122 can generate multiple levels of drill downs. For example, additional drill downs may be presented for selection from a current drill down view. Then, a drill down is selected, for example, to view more detailed information from the current view.

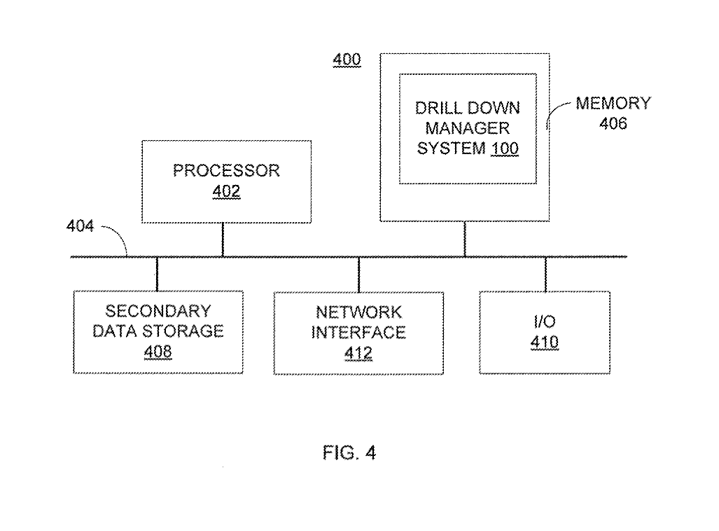

FIG. 4 shows a computer system 400 that may be used with the embodiments described herein. The computer system 400 represents a generic platform that includes components that may be in a server or another computer system. The computer system 400 may be used as a platform for the data storage system 100. The computer system 400 may execute, by one or more processors or other hardware processing circuits, the methods, functions and other processes described herein. These methods, functions and other processes may be embodied as machine readable instructions stored on computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 400 includes a processor 402 that may implement or execute machine readable instructions performing some or all of the methods, functions and other processes described herein. Commands and data from the processor 402 are communicated over a communication bus 404. The computer system 400 also includes a main memory 406, such as a random access memory (RAM), where the machine readable instructions and data for the processor 402 may reside during runtime, and a secondary data storage 408, which may be non-volatile and stores machine readable instructions and data. For example, machine readable instructions for the drill down manager system 100 may reside in the memory 406 during runtime. The memory 406 and secondary data storage 408 are examples of computer readable mediums.

The computer system 400 may include an I/O device 410, such as a keyboard, a mouse, a display, etc. For example, the I/O device 410 includes a display to display drill down views and other information described herein. The computer system 400 may include a network interface 412 for connecting to a network. Other known electronic components may be added or substituted in the computer system 400. Also, the drill down manager system 100 may be implemented in a distributed computing environment, such as a cloud system.

While the embodiments have been described with reference to examples, various modifications to the described embodiments may be made without departing from the scope of the claimed embodiments.

What is claimed is:

1. A drill down manager system comprising:
an introspect module executed by at least one processor to determine fields in each of a plurality of visual components, and to determine data outputs for a drill down;
a mappings module to map the drill down to map a visual component of the plurality of visual components to the drill down based on the determined fields and the data outputs; and
an execution module to execute the drill down and present the data outputs for the drill down in the visual component mapped to the drill down.

2. The drill down manager system of claim 1, wherein the mappings module is to map the drill down to multiple visual components of the plurality of visual components based on the determined fields and the data outputs, and the execution module is to present the data outputs for the drill down in the multiple visual components.

3. The drill down manager system of claim 2, wherein the multiple visual components comprise multiple different types of visual components to display the data outputs of the drill down in different formats.

4. The drill down manager system of claim 2, wherein the multiple visual components comprise at least some of an active channel, query viewer, data monitor and dashboard.

5. The drill down manager system of claim 4, wherein one of the multiple visual components mapped to the drill down is to display a portion of the data outputs and another one of the multiple visual components mapped to the drill down is to display a remaining portion of the data outputs.

6. The drill down manager system of claim 1, wherein the drill down manager system is to receive a new drill down and the mappings module is to map the new drill down to a visual component of the plurality of visual components.

7. The drill down manager system of claim 1, wherein the drill down manager system is to receive a new visual component and the mappings module is to map the new visual component to the drill down if the new visual component includes fields for the data outputs.

8. The drill down manager system of claim 1, wherein the mappings module is to map the drill down to the visual component based on data types and data constraints for the drill down.

9. The drill down manager system of claim 8, wherein the mappings module is to map the drill down to the visual component by identifying the visual component that includes fields for the data outputs, data types and data constraints for the drill down.

10. The drill down manager system of claim 1, wherein the execution module is to determine if the drill down includes a function for calculating an output of the data outputs, and performing the function to calculate the output if the drill down includes the function.

11. The drill down manager system of claim 1, wherein the system is to group a plurality of drill downs into a plurality of categories, and present a subset of the plurality of drill downs in one of the plurality of categories to a user for selection based on a matching of the user to the one of the plurality of categories.

12. The drill down manager system of claim 1, comprising:
a drill down creation module to receive information comprising data inputs, the data outputs, and a function to calculate one of the data outputs for the drill down and to store the information for the drill down in a data storage.

13. The drill down manager system of claim 1, comprising:
a visual component creation module to identify a template to create a visual component and receive fields to include in the template to create the visual component.

14. A non-transitory computer readable medium include machine readable instructions executable by at least one processor to:
determine fields in each of a plurality of visual components;
determine data outputs for a drill down, wherein the data outputs include information from event data processed by an event processing engine to correlate events from a plurality of different sources;
map the drill down to map a visual component of the plurality of visual components to the drill down based on the determined fields and the data outputs; and
execute the drill down and present the data outputs for the drill down in the visual component mapped to the drill down.

15. A method comprising:
determining fields in each of a plurality of visual components;
determining data outputs for a drill down;
identifying, by at least one processor, multiple visual components of the plurality of visual components that include fields for the data outputs of the drill down; and
mapping the multiple visual components to the drill down.
